(19) United States
(12) Patent Application Publication
(10) Pub. No.: US 2014/0319915 A1
(43) Pub. Date: Oct. 30, 2014

(54) POWER ADAPTER WITH PROPORTIONAL CURRENT SHARING AND MOBILE ELECTRONIC DEVICE HAVING THE SAME

(71) Applicant: CHICONY POWER TECHNOLOGY CO., LTD., New Taipei CIty (TW)

(72) Inventors: Wei-Chun LEE, New Taipei City (TW); Sen-Chi LIN, New Taipei City (TW); Fu-Sung CHEN, New Taipei City (TW)

(73) Assignee: Chicony Power Technology Co., Ltd., New Taipei City (TW)

(21) Appl. No.: 13/869,701

(22) Filed: Apr. 24, 2013

(51) Int. Cl. H02J 1/10

(52) U.S. Cl. CPC H02J 1/10
USPC 307/52

(57) ABSTRACT

A power adapter with proportional current sharing is provided to supply power for a mobile electronic device. The power adapter includes a plurality of power modules. Each power module has a power unit, a current-sharing integrated circuit, and a shunt resistor. The power unit receives an external power source and provides an output power. The current-sharing integrated circuit is electrically connected to the power unit. The shunt resistor is electrically connected between a power output terminal of the power unit and the current-sharing integrated circuit. When the power modules are electrically connected in parallel to each other, each power units provides a connection signal to the mobile electronic device via the corresponding shunt resistor. In addition, the current-sharing integrated circuits are used to distribute output power of the corresponding power unit according to the required of the mobile electronic device.

### BACKGROUND

1. Technical Field

The present disclosure relates generally to a power adapter and a mobile electronic device having the same, and more particularly to a power adapter with a proportional current sharing and a mobile electronic device having the same.

2. Description of Related Art

With the advent of the E-generation, electronic products surround us almost everywhere. In order to meet convenience, popularity, and health for consumers, many electronic devices are produced toward the trend of light, thin, short, and small. In addition, because the volume, weight, and stability of the electronic device are closely related to the power supply, the design of the power supply is more important.

At present, the proportional current-sharing technology is mostly applied to the redundant power supply of the server, but it is rarely applied to the field of small-power power adapter. However, the miniaturization and lightweight of the power adapter nowadays is very restricted. When the user needs to carry outdoors the mobile electronic device, such the notebook computer, the tablet computer, and so on, the user usually also needs to carry the corresponding power adapter for the mobile electronic device so as to operate the mobile electronic device for a long time. It is inconvenient and heavy, however, once the user needs to carry outdoors plural mobile electronic devices.

Accordingly, it is desirable to provide a power adapter with proportional current sharing and mobile electronic device having the same that use the current-sharing technology by current-sharing integrated circuits to proportionally control the output power of the in-parallel power modules, and the power adapter is modularized to be easily installed and detached to provide more flexible supply capacity and conveniently carried outdoors.

### SUMMARY

An object of the invention is to provide a power adapter with a proportional current sharing to solve the above-mentioned problems. Accordingly, the power adapter with proportional current sharing is provided to supply power to a mobile electronic device. The power adapter includes a plurality of power modules. Each power module includes a power unit, a current-sharing integrated circuit, and a shunt resistor. The power unit has a power output terminal and a signal output terminal and the power unit receives an external power and generates an output power. The current-sharing integrated circuit is electrically connected to the power output terminal and the signal output terminal of the power unit. The shunt resistor is electrically connected between the power output terminal of the power unit and the current-sharing integrated circuit. Each power module provides a connecting signal to the mobile electronic device via the shunt resistor when the power modules are connected in parallel, and the current-sharing integrated circuits proportionally control the output power of the corresponding power module to supply to the mobile electronic device according to the required power of the mobile electronic device.

Another object of the invention is to provide a method of an induction cooker with a time-sharing control function to solve the above-mentioned problems. Accordingly, the mobile electronic device having a power adapter with proportional current sharing includes a mobile electronic device and a power adapter. The power adapter includes a plurality of power modules, and each power module includes a power unit, a current-sharing integrated circuit, and a shunt resistor. The power unit has a power output terminal and a signal output terminal, and the power unit is configured to receive an external power and generate an output power. The current-sharing integrated circuit is electrically connected to the power output terminal and the signal output terminal of the power unit. The shunt resistor is electrically connected between the power output terminal of the power unit and the current-sharing integrated circuit. Each power module provides a connecting signal to the mobile electronic device via the shunt resistor when the power modules are connected in parallel, and the current-sharing integrated circuits proportionally control the output power of the corresponding power module to supply to the mobile electronic device according to the required power of the mobile electronic device.

It is to be understood that both the foregoing general description and the following detailed. description are exemplary, and are intended to provide further explanation of the invention as claimed. Other advantages and features of the invention will be apparent from the following description, drawings and claims.

### BRIEF DESCRIPTION OF DRAWINGS

The features of the present disclosure believed to be novel are set forth with particularity in the appended claims. The present disclosure itself, however, may be best understood by reference to the following detailed description of the present disclosure, which describes an exemplary embodiment of the present disclosure, taken in conjunction with the accompanying drawings, in which:

FIG. 1 is a schematic circuit block diagram of a power adapter with proportional current sharing according to the present disclosure;

FIG. 2A is a schematic view for use a mobile electronic device having the power adapter with proportional current sharing according to a first embodiment of the present disclosure;

FIG. 2B is a schematic view for use the mobile electronic device having the power adapter with proportional current sharing according to a second embodiment of the present disclosure; and

FIG. 2C is a schematic view for use the mobile electronic device having the power adapter with proportional current sharing according to a third embodiment of the present disclosure.

### DETAILED DESCRIPTION

Reference will now be made to the drawing figures to describe the present disclosure in detail.

The present invention discloses a power adapter with proportional current sharing which is provided to supply power to a mobile electronic device. The power adapter includes a plurality of power modules. Each power module includes a power unit, a current-sharing integrated circuit, and a shunt resistor. The power unit has a power output terminal and a signal output terminal and the power unit receives an external power and generates an output power. The current-sharing integrated circuit is electrically connected to the power output terminal and the signal output terminal of the power unit. The shunt resistor is electrically connected between the power output terminal of the power unit and the current-sharing integrated circuit. Each power module provides a connecting signal to the mobile electronic device via the shunt resistor when the power modules are connected in parallel, and the current-sharing integrated circuits proportionally control the output power of the corresponding power module to supply to the mobile electronic device according to the required power of the mobile electronic device.

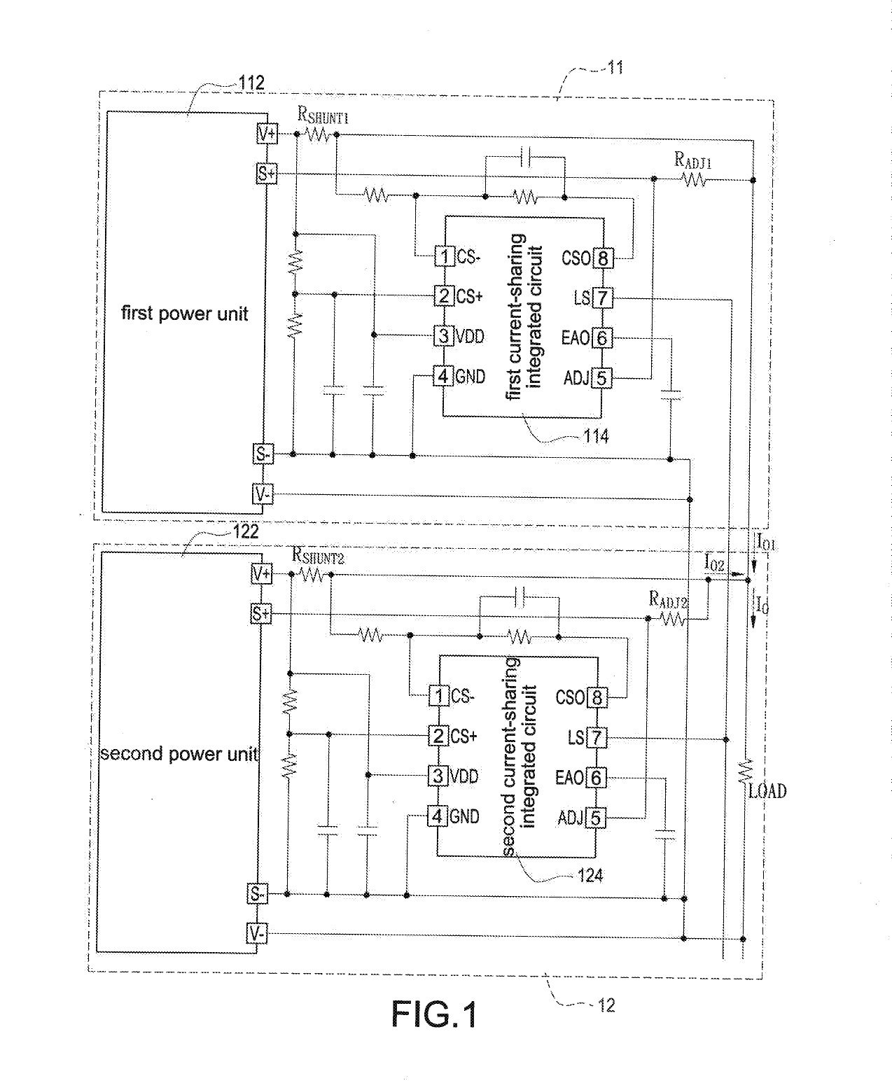

Reference is made to FIG. 1 which is a schematic circuit block diagram of a power adapter with proportional current sharing according to the present disclosure. For convenience, it is assumed that the power adapter includes two power modules, namely a first power module 11 and a second power module 12. The first power module 11 mainly has a first power unit 112, a first current-sharing integrated circuit 114, and a first shunt resistor R_{SHUNT1}. The first current-sharing integrated circuit 114 is electrically connected to the power output terminal V+ and the signal output terminal S+ of the first power unit 112. The first shunt resistor R_{SHUNT1} is electrically connected between the power output terminal V+ of the first power unit 112 and the first current-sharing integrated circuit 114. The second power module 12 mainly has a second power unit 122, a second current-sharing integrated circuit 124, and a second shunt resistor R_{SHUNT2}. The second current-sharing integrated circuit 124 is electrically connected to the power output terminal V+ and the signal output terminal S+ of the second power unit 122. The second shunt resistor R_{SHUNT2} is electrically connected between the power output terminal V+ of the second power unit 122 and the second current-sharing integrated circuit 124.

When the first power module 11 is electrically connected in parallel to the second power module 12, the first power unit 112 generates a first connecting signal to the mobile electronic device via the first shunt resistor R_{SHUNT1} and the second power unit 122 generates a second connecting signal to the mobile electronic device via the second shunt resistor R_{SHUNT2} so that the output powers of the first power unit 112 and the second power unit 122 can be detected by the mobile electronic device. Especially, resistance values of the first shunt resistor R_{SHUNT1} and the second shunt resistor R_{SHUNT2} are decided and provided by the manufacturer of the mobile electronic device. Accordingly, the output powers of the first power unit 112 and the second power unit 122 can be detected by the mobile electronic device after the mobile electronic device receives and judges the first connecting signal and the second connecting signal. Afterward, the output power of the first power unit 112 and the output power of the second power unit 122 are correspondingly distributed by the first current-sharing integrated circuit 114 and the second current-sharing integrated circuit 124, respectively, according to the required power of the mobile electronic device so as to correctly supply power to the mobile electronic device. In particular, the resistance values of the first shunt resistor R_{SHUNT1} and the second shunt resistor R_{SHUNT2} are inversely proportional to rated output powers of the first power module 11 and the second power module 12. That is, a relationship between a resistance value ratio of the first shunt resistor R_{SHUNT1} to the second shunt resistor R_{SHUNT2} and a rated output power ratio of the first power module 11 to the second power module 12 is R_{SHUNT1}: R_{SHUNT2}=P12:P11. In which, the terms P11 and P12 express the rated output power of the first power module 11 and the rated output power of the second power module 12, respectively. In other words, magnitude of a load current Io flowing through a load LOAD supplied by the power adapter is equal to a sum of magnitude of a first output current Io1 outputted from the first power module 11 and magnitude of a second output current Io2 outputted from the second power module 12. Especially, the first output current Io1 and the second output current Io2 are acquired by the current-sharing control. manner of controlling the first power module 11 by the first current-sharing integrated circuit 114 and controlling the second power module 12 by the second current-sharing integrated circuit 124, respectively.

Especially, the first current-sharing integrated circuit 114 has a load sharing pin LS and the second current-sharing integrated circuit 124 has also a load sharing pin LS. When the first power module 11 is electrically connected in parallel to the second power module 12, the two load sharing pins LS would be electrically connected to each other. That is, the mobile electronic device can detect whether the first power module 11 and the second power module 12 have already connected to each other according to connection conditions between the load sharing pin Ls of the first current-sharing integrated circuit 114 and the load sharing pin LS of the second current-sharing integrated circuit 124. The first power module 11 further has a first adjustment resistor R_{ADJ1}. The first adjustment resistor R_{ADJ1} is electrically connected to the signal output terminal S+ of the first power unit 112 and an adjustment pin ADJ of the first current-sharing integrated circuit 114 to fine adjust an output voltage of the first power module 11. Similarly, the second power module 12 further has a second adjustment resistor R_{ADJ2}. The second adjustment resistor R_{ADJ2} is electrically connected to the signal output terminal S+ of the second power unit 122 and an adjustment pin ADJ of the second current-sharing integrated circuit 124 to fine adjust an output voltage of the second power module 12. The detailed operation of using the mobile electronic device with the power modules will he described hereinafter as follows.

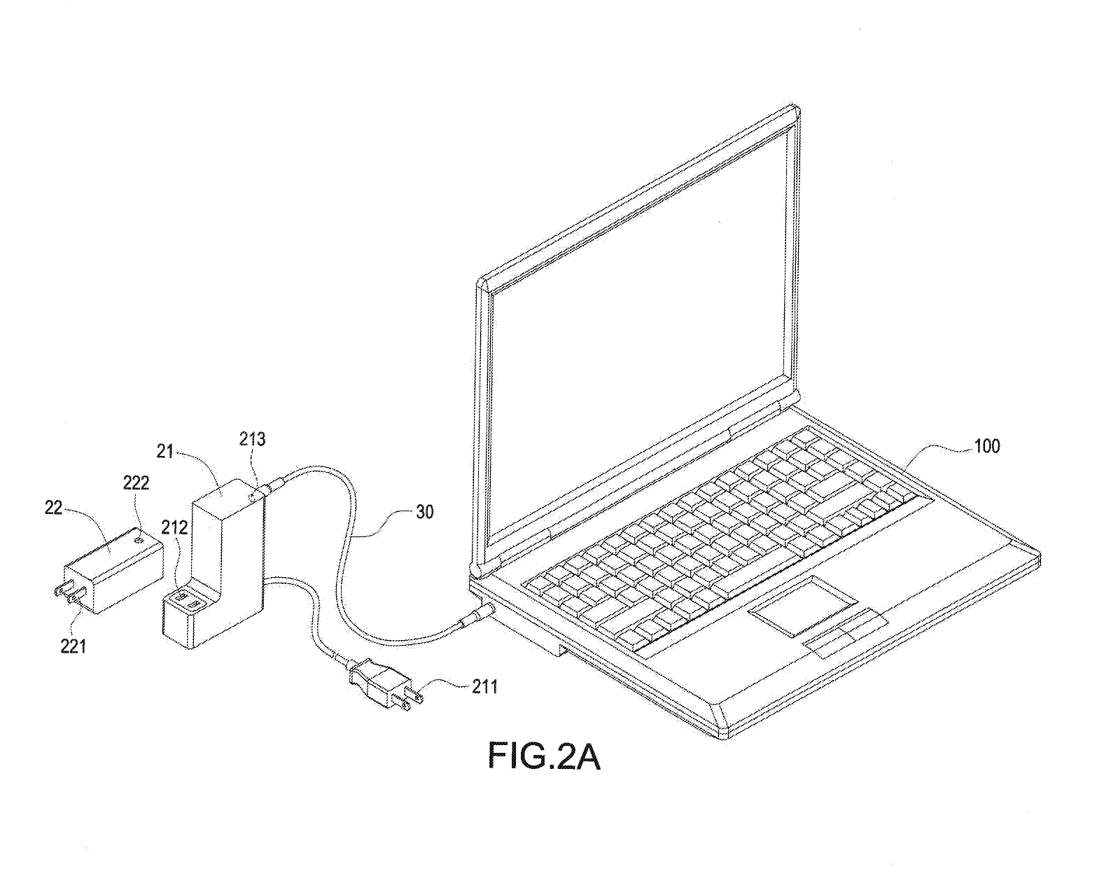

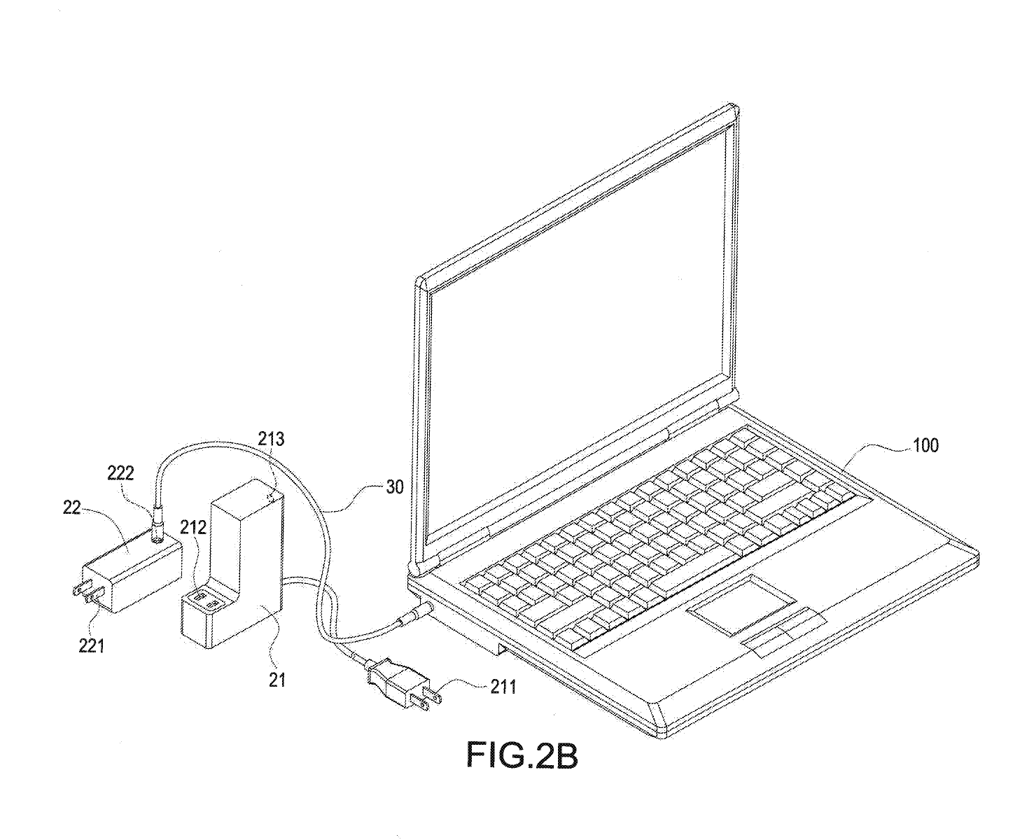

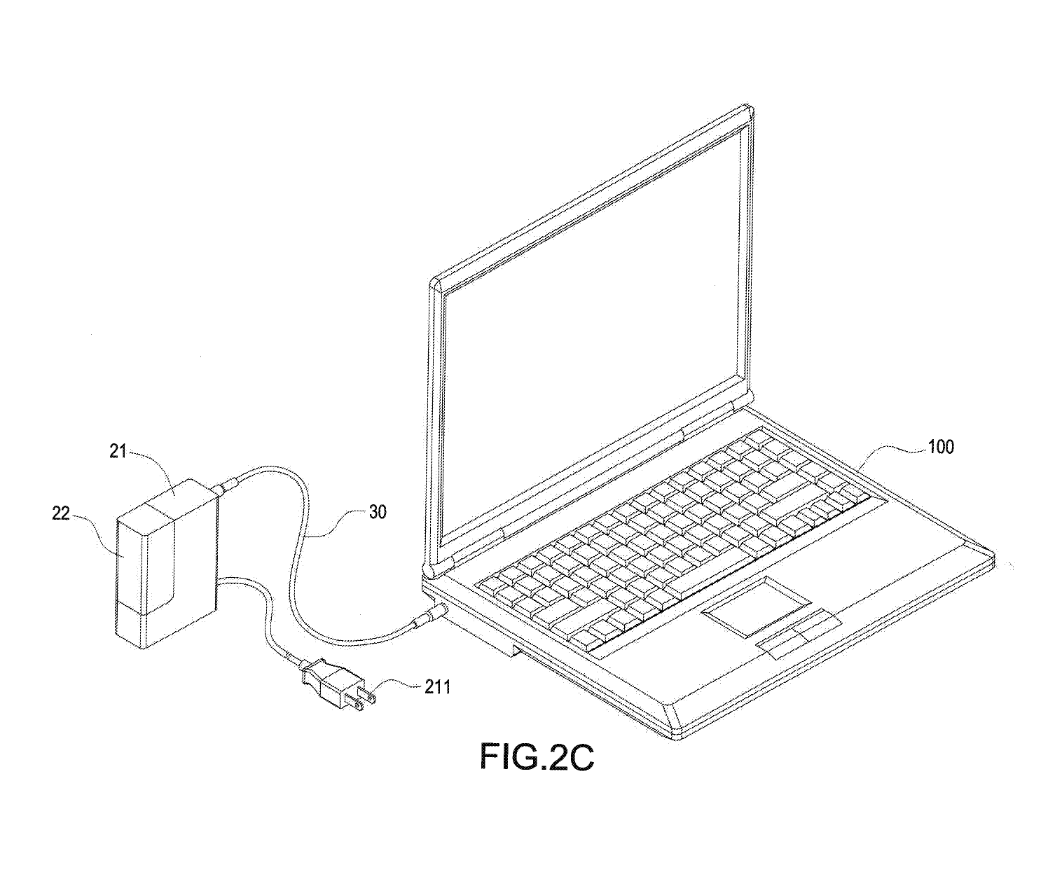

Reference is made to FIG. 2A, FIG. 2B, and FIG. 2C which are a schematic view for use a mobile electronic device having the power adapter with proportional current sharing according to a first embodiment, a second embodiment, and a third embodiment of the present disclosure, respectively. In these embodiments, two power modules are exemplified for further demonstration. As shown in FIG. 2A, the first power module 21 has a first plug 211, an outlet 212, and a first connecting terminal 213; the second power module 22 has a second plug 221 and a second connecting terminal 222. Especially, the second power module 22 can be inserted in the first power module 21 to form an electrical connection (as shown in FIG. 2C and described hereinafter) and then to supply power to the mobile electronic device. In addition, the first power module 21 and the second power module 22 can also separately supply power to the mobile electronic device. In these embodiments, the mobile electronic device can be a notebook computer 100, a tablet computer, a smart phone, and so on. However, the embodiments are only exemplified but are not intended to limit the scope of the disclosure.

In the first embodiment, the first power module 21 is connected to the notebook computer 100 via a power connecting wire 30. In particular, the power connecting wire 30 is connected between the first connecting terminal 213 of the first power module 21 and a power input terminal (not labeled) of the notebook computer 100. When the first plug 211 of the first power module 21 is connected to an external AC power source, the first power module 21 can individually convert the AC power into an output power to supply power to the notebook computer 100.

As shown in FIG. 2B, the second power module 22 can individually supply power to the notebook computer 100. At this time, the power connecting wire 30 is connected between the second connecting terminal 222 of the second power module 22 and the power terminal of the notebook computer 100. When the second plug 221 of the second power module 22 is connected to the external AC power source, the second power module 22 can individually convert the AC power into an output power to supply power to the notebook computer 100.

As shown in FIG. 2C, the second power module 22 can be inserted in the first power module 21 to form an electrical connection and then to supply power to the notebook computer 100. More specifically, the second plug 221 of the second power module 22 is directly inserted in the outlet 212 of the first power module 21 so that the second power module 22 is electrically connected in parallel to the first power module 21. When the first plug 211 of the first power module 21 is connected to the external AC power source, the first power module 21 and the second power module 22 can jointly supply power to the notebook computer 100.

In practical applications, the output power of the first power module 21 can be greater than the output power of the second power module 22 so as to provide more flexible supply capacity, but not limited. The user can select the required power module(s) to supply power to the mobile electronic device according to different considerations, such as types of the mobile electronic device, time of using the mobile electronic device, or convenience of carrying the mobile electronic device. More specifically, if the smaller output power is required for the mobile electronic device, the user can carry only the second power module 22 to individually supply power to the mobile electronic device. Also, if the larger output power is required for the mobile electronic device, the user can carry only the first power module 21 to individually supply power to the mobile electronic device or carry both the first power module 21 and the second power module 22 to jointly supply power to the mobile electronic device.

In conclusion, the present disclosure has following advantages:

1. The current-sharing technology is implemented by the current-sharing integrated circuit to proportionally control the output power of the in-parallel power modules;

2. The current-sharing technology is applied to different circuit topologies for the power adapter;

3. The modular power adapter can be easily installed and detached to provide more flexible supply capacity; and

4. The user can select the required power module(s) to supply power to the mobile electronic device according to different considerations, such as types of the mobile electronic device, time of using the mobile electronic device, or convenience of carrying the mobile electronic device.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A power adapter with proportional current sharing provided to supply power to a mobile electronic device, the power adapter comprising:
a plurality of power modules, each power module comprising:
a power unit having a power output terminal and a signal output terminal, the power unit configured to receive an external power and generate an output power;
a current-sharing integrated circuit electrically connected to the power output terminal and the signal output terminal of the power unit; and
a shunt resistor electrically connected between the power output terminal of the power unit and the current-sharing integrated circuit;
wherein each power module provides a connecting signal to the mobile electronic device via the shunt resistor when the power modules are connected in parallel, and the current-sharing integrated circuits proportionally control the output power of the corresponding power module to supply to the mobile electronic device according to the required power of the mobile electronic device.

2. The power adapter with proportional current sharing in claim 1, wherein each current-sharing integrated circuit has a load sharing pin; the load sharing pins of the current-sharing integrated circuit are electrically connected to each other when the power modules are electrically connected in parallel to each other.

3. The power adapter with proportional current sharing in claim 1, wherein each power module further comprises:
an adjustment resistor electrically connected to the signal output terminal of the power unit and an adjustment pin of the current-sharing integrated circuit to fine adjust an output voltage of the power module.

4. The power adapter with proportional current sharing in claim 1, wherein a rated output power ratio of the power modules is inversely proportional to a resistance value ratio of the shunt resistors.

5. A mobile electronic device having a power adapter with proportional current sharing, comprising:
an mobile electronic device; and
a power adapter, comprising a plurality of power modules, and each power module comprising:
a power unit having a power output terminal and a signal output terminal, the power unit configured to receive an external power and generate an output power;
a current-sharing integrated circuit electrically connected to the power output terminal and the signal output terminal of the power unit; and
a shunt resistor electrically connected between the power output terminal of the power unit and the current-sharing integrated circuit;
wherein each power module provides a connecting signal to the mobile electronic device via the shunt resistor when the power modules are connected in parallel, and the current-sharing integrated circuits proportionally control the output power of the corresponding power module to supply to the mobile electronic device according to the required power of the mobile electronic device.

6. The mobile electronic device in claim 5, wherein each current-sharing integrated circuit has a load sharing pin; the load sharing pins of the current-sharing integrated circuit are electrically connected to each other when the power modules are electrically connected in parallel to each other.

7. The mobile electronic device in claim 5, wherein each power module further comprises:
an adjustment resistor electrically connected to the signal output terminal of the power unit and an adjustment pin of the current-sharing integrated circuit to fine adjust an output voltage of the power module.

8. The mobile electronic device in claim 5, wherein a rated output power ratio of the power modules is inversely proportional to a resistance value ratio of the shunt resistors.

9. The mobile electronic device in claim 5, wherein the mobile electronic device is a notebook computer, a tablet computer, or a smart phone.

10. The mobile electronic device in claim 5, wherein the power modules are electrically connected to each other in an insertion manner.
